(19) United States
(12) Patent Application Publication
(10) Pub. No.: US 2024/0080677 A1
(43) Pub. Date: Mar. 7, 2024

(54) COMMUNICATION SYSTEM, CONTROL SERVER APPARATUS, BASE STATION PLACEMENT METHOD AND PROGRAM

(71) Applicant: NIPPON TELEGRAPH AND TELEPHONE CORPORATION, Tokyo (JP)

(72) Inventors: Shota NAKAYAMA, Tokyo (JP); Daisuke MURAYAMA, Tokyo (JP)

(21) Appl. No.: 18/261,906

(22) PCT Filed: Feb. 9, 2021
(86) PCT No.: PCT/JP2021/004803

§ 371 Date: Jul. 18, 2023

(51) Int. Cl. H04W 16/18

(52) U.S. Cl. CPC H04W 16/18; H04W 88/08

(57) ABSTRACT

A communication system including a control server device and a movable base station device includes: generating, by the control server device, one or more terminal clusters obtained by clustering terminal devices on the basis of information about a location and a material of each shielding object in an area and a location of each terminal device; calculating, by the control server device, a location of a movable base station device for each of the terminal clusters; and moving, by the control server device, the movable base station device to the calculated location in each of the terminal cluster.

### TECHNICAL FIELD

The present invention relates to a movable base station installation method in a wireless communication system.

### BACKGROUND ART

The introduction of 5G, which realizes large-capacity systems, high-speed data transmission speeds, low latency, simultaneous connection of many terminals or the like is underway. In 5G, in addition to the frequency bands currently used in movable communications, high frequency bands such as millimeter wave bands are used (NPL 1).

### CITATION LIST

### Non Patent Literature

[NPL 1] Docomo Technical Journal (Vol. 26-1, P. 25-32)

### SUMMARY OF INVENTION

### Technical Problem

Since radio waves in high frequency bands are significantly affected by shielding, there is a concern that communication quality will deteriorate due to changes in the spatial environment. Also, if a plurality of base stations are installed, resources may not be utilized maximally effectively unless they are installed in appropriate locations according to the spatial environment in some cases.

However, in the related art, in order to install a base station at an appropriate location, for example, it is necessary to repeatedly perform trial and error, such as installing base stations in various locations and measuring the actual communication quality, which took time and effort.

The present invention was made in view of the above points, and an object of the present invention is to provide a technique in which a base station is enabled to be easily disposed at an appropriate location in a wireless communication system.

### Solution to Problem

According to the disclosed technique, a communication system including a control server device and a movable base station device includes:
generating, by the control server device, one or more terminal clusters obtained by clustering terminal devices on the basis of information about a location and a material of each shielding object in an area and a location of each terminal device;
calculating, by the control server device, a location of a movable base station device for each of the terminal clusters; and
moving, by the control server device, the movable base station device to the calculated location in each of the terminal clusters.

### Advantageous Effects of Invention

According to the disclosed technique, a technique in which a base station is enabled to be easily disposed at an appropriate location in a wireless communication system is provided.

### BRIEF DESCRIPTION OF DRAWINGS

FIG. 1 is a top view of a warehouse or the like in which shelves and articles are placed when viewed from above.

FIG. 2 is a diagram showing a system throughput.

FIG. 3 is a top view of a warehouse or the like in which shelves or articles are placed when viewed from above

FIG. 4 is a diagram showing a system throughput.

FIG. 5 is a diagram illustrating an example of the overall configuration of a wireless communication system according to an embodiment of the present invention.

FIG. 6 is a configuration diagram of a control server.

FIG. 7 is a configuration diagram a movable base station.

FIG. 8 is a diagram illustrating an example in which a movable base station is installed in a movable structure body.

FIG. 9 is a flowchart for describing an operation example of a control server.

FIG. 10 is a flowchart for describing showing an operation example of a movable base station.

FIG. 11 is a diagram showing a hardware configuration example of a device.

### DESCRIPTION OF EMBODIMENTS

An embodiment (this embodiment) of the present invention will be described below with reference to the drawings. The embodiments described below are merely examples and embodiments to which the present invention is applied are not limited to the following embodiments.

For example, although two-dimensional locations are used as examples of the locations of terminals and base stations in the description of the following embodiments, three-dimensional locations may be used as the locations of terminals and base stations. Also, since a base station, a movable base station, a terminal, and a control server in this specification are all a “device”, they may also be referred to as base station device, a movable base station device, a terminal device, and a control server device.

### (Overview of Embodiment)

It is assumed that a wireless communication system according to this embodiment is a wireless communication system using radio waves of a high frequency band, for example, a 28 GHz band or a higher frequency band. Here, the present invention is also applicable to wireless communication systems in frequency bands other than high frequency bands.

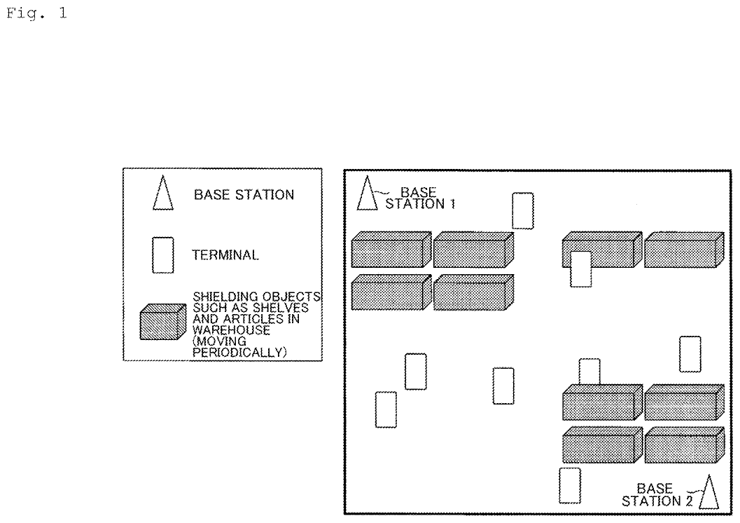

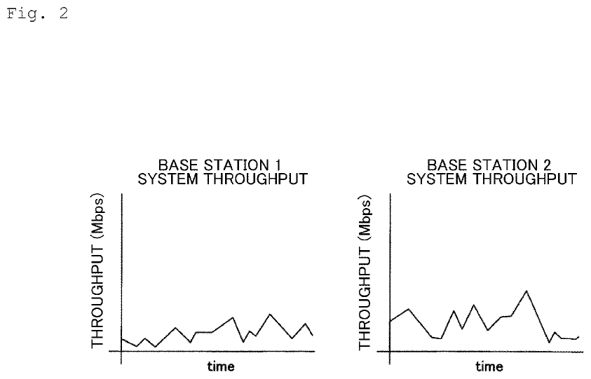

As described above, since high frequency bands are significantly affected by shielding, communication quality may deteriorate due to changes in the spatial environment. This will be described with reference to FIGS. 1 and 2.

FIG. 1 is a top view of a warehouse or the like in which shelves and articles are placed when viewed from above. As shown in FIG. 1, base stations 1 and 2 and a plurality of terminals are disposed along with shelves and articles. The shelves and the articles serve as shielding objects against wireless communication (radio wave propagation). Particularly, in warehouses and the like, shielding objects such as shelves and articles move periodically, which may hinder stable use of high frequency bands. FIG. 2 shows a state in which both of the base station 1 and 2 have low system throughput.

In an environment such as that shown in FIG. 1, the base stations 1 and 2 need to be placed at appropriate locations to improve system throughput. For this reason, in this embodiment, considering the “location and the material of shielding objects” and “location and number of terminals”, the installation location of the base stations and the connection destination of the terminals are controlled so that the base stations can be easily arranged at locations close to the optimum.

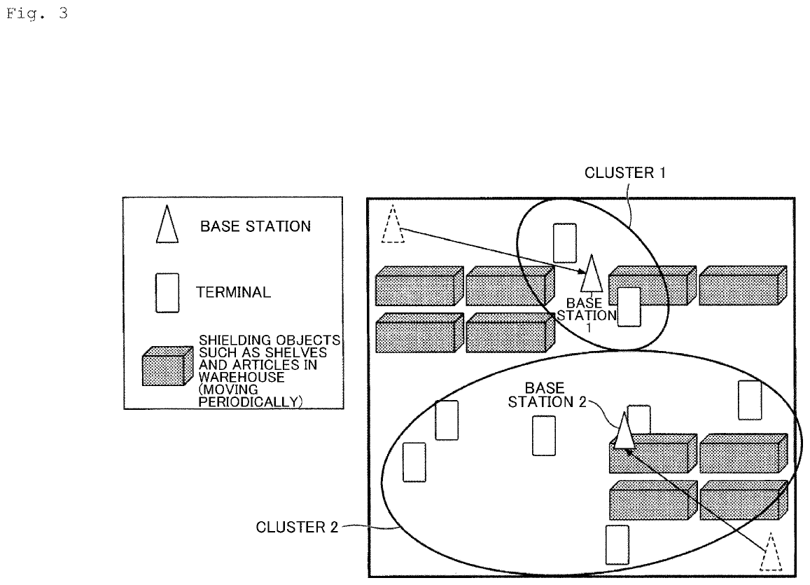

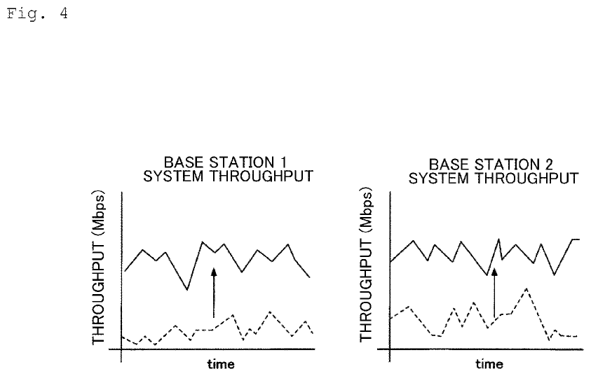

More specifically, as shown in FIG. 3, terminals are clustered (terminal clusters are generated) in consideration of the locations and the materials of the shielding objects and the base stations are disposed at optimum locations for each terminal cluster. In the example shown in FIG. 3, the base station 1 is disposed in the cluster 1 and the base station 2 is disposed in the cluster 2. Such control improves the system throughput of each base station as shown in FIG. 4.

Although any method may be used to move the base station in this embodiment, for example, the base station can be installed in a drone (or another flying object) and the base station can be moved by moving the drone.

That is, according to this embodiment, it is possible to secure line-of-sight to terminals which are not in line-of-sight from the base station before movement and improve system throughput by installing a base station on a drone or the like and installing it in a predetermined location (such as on a shelf).

Furthermore, it is possible to improve the followability of the base station in an environment such as a warehouse in which shelves and articles move regularly. In addition, since a mutual influence between clusters is not taken into consideration in this embodiment, it is possible to reduce an amount of calculation.

A system configuration and an operation of this embodiment will be described in detail below.

### (Overall Configuration)

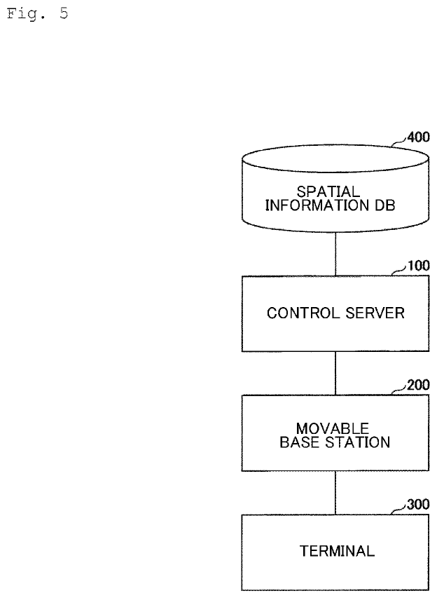

FIG. 5 shows an example of the overall configuration of a wireless communication system according to this embodiment. As shown in FIG. 5, a wireless communication system according to this embodiment has a control server 100, a movable base station 200, a terminal 300, and a spatial information DB (database) 400. Although only one movable base station 200 and one terminal 300 are shown, a plurality of movable base stations 200 and a plurality of terminals 300 may be provided.

The control server 100 may be disposed on a cloud or may be disposed on a network (wireless LAN or wired LAN or the like) together with the movable base station 200. The spatial information DB 400 may also be disposed on the cloud or may be disposed on the network.

The spatial information DB 400 stores information about a shielding object and information about a terminal. More specifically, the spatial information DB 400 stores, for example, a shape (including thickness), location in an area, a material, an attenuation amount per unit thickness, or the like, for each shielding object. Note that the attenuation amount per unit thickness may be calculated by the control server 100 from the material. Also, the spatial information DB 400 stores, for example, the current location, the base station to which the terminal is connected, and the like for each terminal.

The control server 100 acquires information from the spatial information DB 400 and controls the movable base station 200 on the basis of the acquired information.

The movable base station 200 is disposed at a location in which communication between the movable base station 200 and the control server 100 is possible and has the terminal 300 accommodated therein. The terminal 300 is connected to the movable base station 200 and connected to a local network or the Internet via the movable base station 200.

### (Configuration of Control Server 100)

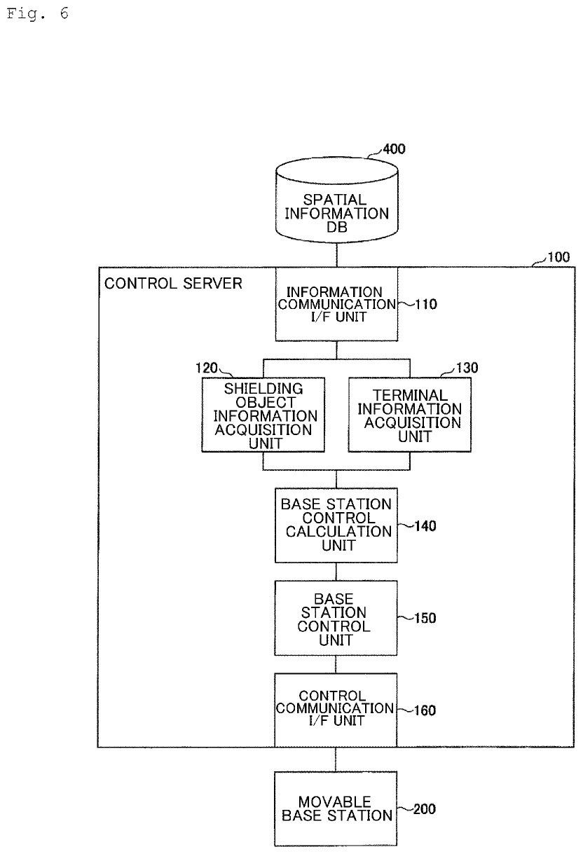

FIG. 6 shows a configuration example of the control server 100. As shown in FIG. 6, the control server 100 includes an information communication I/F unit 110, a shielding object information acquisition unit 120, a terminal information acquisition unit 130, a base station control calculation unit 140, a base station control unit 150, and a control communication I/F unit 160.

The information communication I/F unit 110 is connected to the spatial information DB 400 and transmits and receives shielding object information and terminal information.

The shielding object information acquisition unit 120 acquires information such as a shape, a location, and a material of the shielding object from the spatial information DB 400. The terminal information acquisition unit 130 acquires the location information and the like of the terminal 300 from the spatial information DB 400.

The base station control calculation unit 140 acquires information about the shielding object and the terminal 300 from the shielding object information acquisition unit 120 and the terminal information acquisition unit 130, respectively, and calculates the installation location of the movable base station 200 and the connection destination of the terminal 300.

The base station control unit 150 controls the movable base station 200 on the basis of the results calculated using the base station control calculation unit 140. The control communication I/F unit 160 is connected to the movable base station 200 and transmits and receives control communication. Note that, with regard to control of a connection destination of the terminal 300, the base station control unit 150 may instruct the movable base station 200 so that the movable base station 200 controls the connection destination to the terminal 300 or may provide an command of the connection destination to the terminal 300.

### (Configuration Example of Movable Base Station 200)

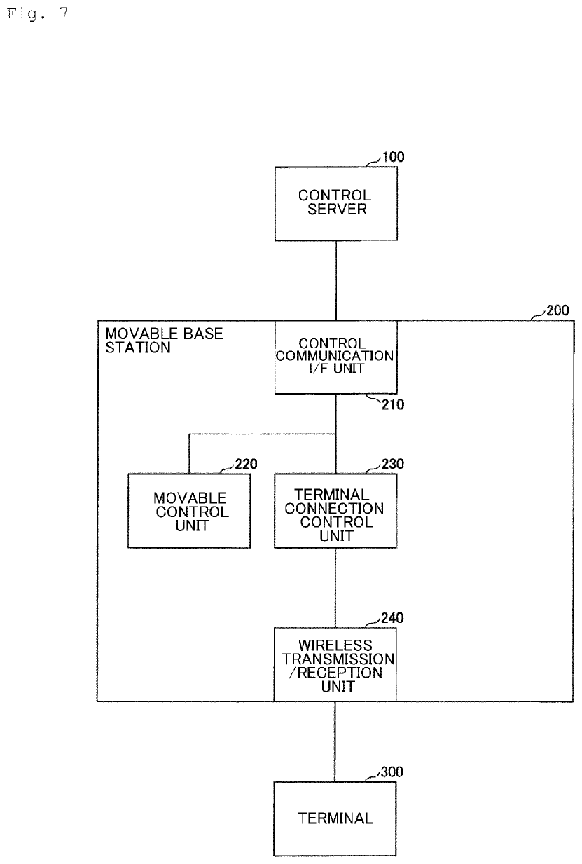

FIG. 7 shows a configuration example of the movable base station 200. As shown in FIG. 7, the movable base station 200 has a control communication I/F unit 210, a movable control unit 220, a terminal connection control unit 230, and a wireless transmission/reception unit 240. Note that FIG. 7 particularly shows functions relating to location control and terminal control in the movable base station 200.

The control communication I/F unit 210 is connected to the control server 100 and transmits and receives control information. The movable control unit 220 receives control information from the control server 100 and controls the location of the movable base station 200.

The terminal connection control unit 230 receives control information from the control server 100 and controls connection of the terminal 300. Also, the terminal connection control unit 230 changes the connection destination of the target terminal 300. A wireless transmission/reception unit 240 is connected to the terminal 300 and transmits/receives a connection destination control signal for the terminal 300.

Note that, when the movable base station 200 is installed in, for example, a drone, the movable control unit 220 receives information about a location in which the movable base station 200 needs to be disposed from the control server 100 and instructs the drone so that the drone moves to the location.

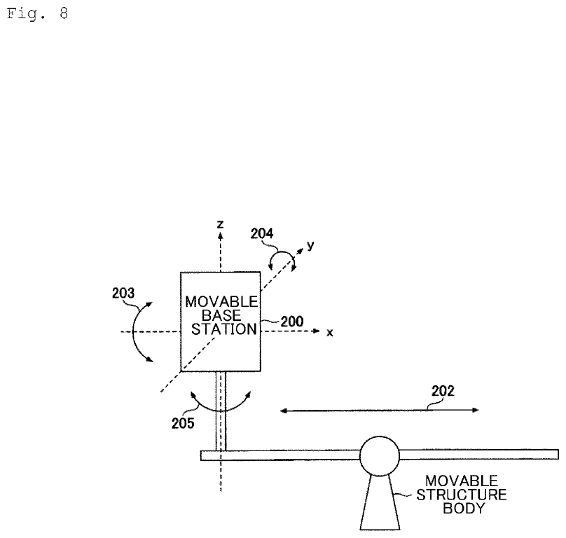

Also, as shown in FIG. 8, the movable base station 200 may be configured to have a structure having a movable structure body configured to support the movable base station 200. The movable structure body moves the movable base station 200 in a direction of an arrow 201, for example, on the basis of the location information transmitted from the control server 100. Furthermore, the movable structure body may rotatably move the movable base station 200 around an x-axis (refer to reference numeral 203), a y-axis (refer to reference numeral 204), and a z-axis (refer to reference numeral 205), for example, on the basis of the control information transmitted from the control server 100.

Moreover, the control server 100 may manually move the movable structure body on which the movable base station 200 is installed in a terminal cluster, which will be described later, and perform detailed location control.

An operation of each device will be described below with reference to a flowchart.

### (Operation Example of Control Server 100)

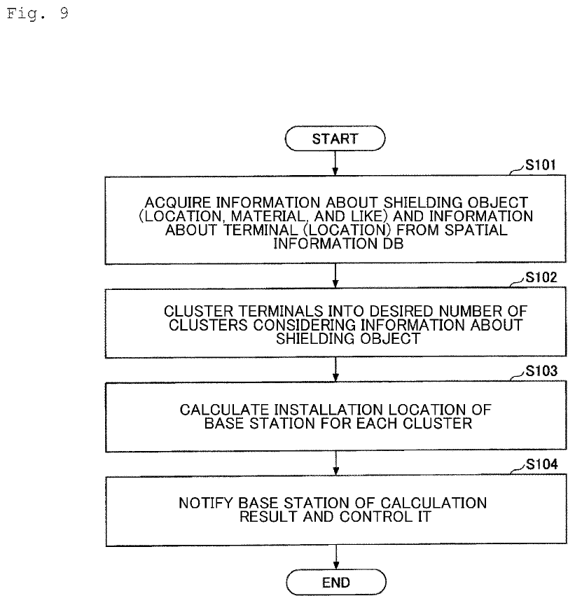

An operation example of the control server 100 will be described with reference to the procedure of the flowchart of FIG. 9.

### <S101>

In S101, the shielding object information acquisition unit 120 acquires information (location, material, or the like) about a shielding object from a spatial information DB 400 and a terminal information acquisition unit 130 acquires information (location of each terminal) of a terminal 300 from the spatial information DB 400.

### <S102>

In S102, the base station control calculation unit 140 clusters the terminals 300 into a desired number of clusters in consideration of the information about the shielding object. The details of the processing herein will be described later.

### <S103>

In S103, the base station control unit 150 calculates the installation location of the movable base station 200 for each cluster. The details of the calculation method will be described later.

### <S104>

In S104, the base station control unit 150 notifies the movable base station 200 of the calculation result and controls it. For example, the base station control unit 150 transmits, to the movable base station 200, information about the location in which the movable base station 200 needs to be disposed and an command to move to that location. The base station control unit 150 may further transmit, to the movable base station 200, identification information of each terminal in the terminal cluster in which the movable base station 200 is disposed and may transmit an command to each terminal to transmit a control signal for connecting to the movable base station 200.

### <Regarding Method of Generating Terminal Cluster>

A method of generating a terminal cluster in S102 will be described in detail. The base station control calculation unit 140 forms a cluster from the terminal having the shortest distance between terminals in consideration of the shielding object. A specific processing procedure is as follows.

### (S1)

In S1, the base station control calculation unit 140 sets each terminal as a separate terminal cluster (initial).

### (S2)

In S2, the base station control calculation unit 140 acquires the distances between all terminal clusters. The distance between terminal clusters may be an average value of the distances for each set of elements (terminals) between two terminal clusters, may be the shortest value among the distances for each set of elements (terminals) of two terminal clusters, may be the longest value among the distances for each set of elements (terminals) of two terminal clusters, or may be a statistical value other than these.

The distance for each set of elements (terminals) between two terminal clusters is, for example, a terminal cluster A with terminals A1 and A2, and when a terminal cluster B has terminals B1 and B2, a distance between the terminal A1 and the terminal B1, a distance between the terminal A1 and the terminal B2, a distance between the terminal A2 and the terminal B1, and a distance between the terminal A2 and the terminal B2.

Examples of distances between elements (terminals) between terminal clusters are as follows.

It is assumed that a distance between a terminal xn in one terminal cluster and a terminal xm in another terminal cluster is d(xn,xm).

When there is a shielding object between xn and xm, it is assumed that d(xn,xm)=(Euclidean distance between xn and xm)+a×b is satisfied.

a is an attenuation amount per thickness [m] of the shielding object (converted distance of free space loss) and b is the thickness of the shielding object.

When there is no shielding object between xn and xm, it is assumed that d(xn,xm)=(Euclidean distance between xn and xm) is satisfied.

### (S3)

The base station control calculation unit 140 combines a combination of terminal clusters with the smallest inter-terminal cluster distance to form a new terminal cluster.

### (S4)

The base station control calculation unit 140 repeatedly performs S2 and S3 until the desired number of terminal clusters is obtained. The desired number of terminal clusters is the number of movable base stations 200. Here, the present invention is not limited to this.

Subsequently, an example of a method of calculating the location of the movable base station 200 for each terminal cluster in S103 described above will be described. Calculation Method Example 1 and Calculation Method Example 2 of the location of the movable base station 200 will be described below. Either Calculation Method Example 1 or Calculation Method Example 2 may be used.

### <Calculation Method Example 1 for Location of Movable Base Station 200>

In Calculation Method Example 1 of the location of the movable base station 200, the base station control calculation unit 140 searches for the optimum location of the movable base station 200 for each terminal cluster. Specifically, the location of the movable base station 200 is calculated in the following procedure.

### (S1)

In S1, the base station control calculation unit 140 sets an area (for example, an area in a target warehouse) in a mesh shape (which may be expressed as a lattice shape) having d[m] intervals and each vertex of each mesh (square) is set as a retrieval location for the movable base station 200.

### (S2)

In S2, the base station control calculation unit 140 counts the number of terminals in line of sight between the elements (terminals) in the target terminal cluster and the movable base station 200 at each retrieval location and uses the installation location of the movable base station 200 as the location with the largest number of terminals in line of sight. In addition to this method, the installation location of the movable base station 200 may be the location in which the total radio wave attenuation amount (assumed value) between the terminal in the target terminal cluster and the movable base station 200 is the smallest for all terminals in the cluster. The amount of radio wave attenuation amount may be obtained by radio wave propagation simulation or the like.

### (S3)

In S3, the base station control calculation unit 140 performs S2 for all terminal clusters.

### <Calculation Method Example 2 of Location of Movable Base Station 200>

In Calculation Method Example 2 of the location of the movable base station 200, the base station control calculation unit 140 installs the movable base station 200 at the center of gravity of the terminal cluster considering the material and the shape of the shielding object. Specifically, the location of the movable base station 200 is calculated in the following procedure. The following procedure is performed for each terminal cluster.

### (S1)

In S1, the base station control calculation unit 140 obtains the center of gravity G of the terminal cluster. In S1, all the weights of the elements (terminals) of the terminal cluster are set to one.

### (S2)

In S2, the base station control calculation unit 140 sets the weight of the element to d×b when there is a shielding object between the center of gravity G of the terminal cluster and the element of the terminal cluster. Here, d is the weight for attenuation amount per shielding object thickness [m] and b is the shielding object thickness [m].

### (S3)

In S3, the base station control calculation unit 140 calculates the center of gravity G′ of the terminal cluster again and determines to dispose the movable base station 200 at G′.

For example, it is assumed that the coordinates of the center of gravity G′ are (x_{G}, y_{G}), the unweighted location of the terminal UEi is (xᵢ, yᵢ), the number of terminals in the cluster is n, and for example, when there is a shielding object between the location (x₃, y₃) of the terminal UE3 and the center of gravity G calculated in S1, G′(x_{G}, y_{G}) can be calculated by the following expression:

G′(x_{G},y_{G})=((x₁+x₂+dbx₃+ . . . +xₙ)/(1+1+db+ . . . +1),(y₁+y₂+dby₃+ . . . +yₙ)/(1+1+db+ . . . ) 1))

Note that the method of calculating the weight and the method of adding the weight to the center of gravity are not limited to the above methods and other methods may be used.

### (Example of Operation of Movable Base Station 200)

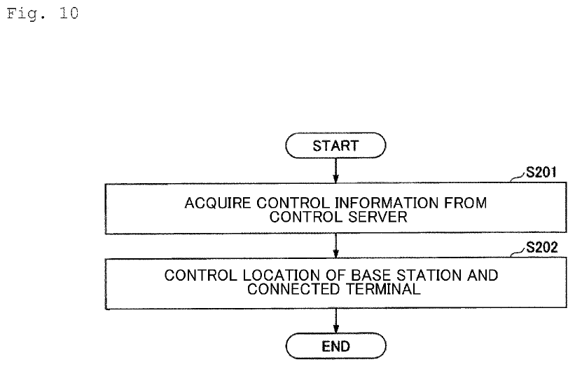

An operation example of the movable base station 200 will be described with reference to the procedure of the flowchart in FIG. 10.

### <S201>

The movable control unit 220 of the movable base station 200 receives, from the control server 100, for example, information about the location in which the movable base station 200 needs to be disposed and a command to move to that location as control information. Also, the terminal connection control unit 230 of the movable base station 200 receives, from the control server 100, for example, identification information of each terminal belonging to the terminal cluster corresponding to the location in which the movable base station 200 is disposed and, as control information, an command transmission command to each terminal so that each terminal is connected to the movable base station 200.

### <S201>

The movable control unit 220 of the movable base station 200 moves the movable base station 200 in accordance with the control information. Also, the terminal connection control unit 230 of the movable base station 200 transmits a connection command to each terminal belonging to the terminal cluster in accordance with the control information.

### (Hardware Configuration Example)

The control server 100 in this embodiment can be implemented, for example, by causing a computer to execute a program describing the processing details described in this embodiment. Note that this “computer” may be a physical machine or a virtual machine on the cloud. When using a virtual machine, the “hardware” described herein is virtual hardware.

The above program can be recorded in a computer-readable recording medium (portable memory or the like), saved, or distributed. Also, it is possible to provide the above program through a network such as the Internet or e-mail.

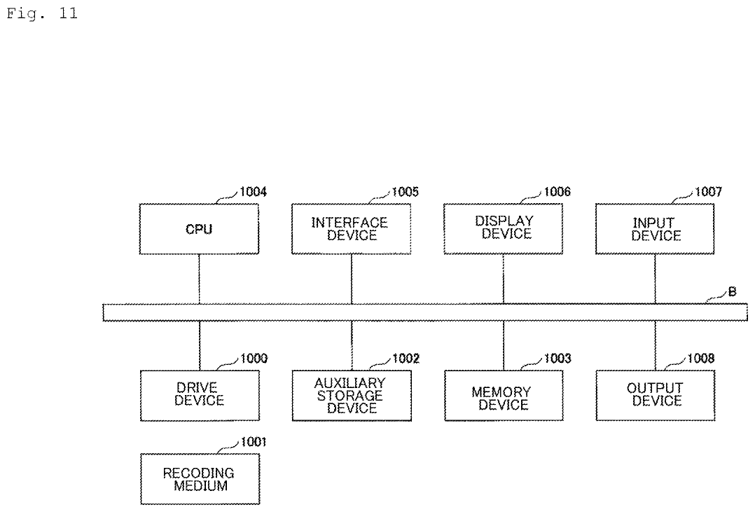

FIG. 11 is a diagram showing a hardware configuration example of the computer. The computer of FIG. 11 has a drive device 1000, an auxiliary storage device 1002, a memory device 1003, a CPU 1004, an interface device 1005, a display device 1006, an input device 1007, an output device 1008, and the like which are connected to each other via a bus B, respectively.

A program for realizing processing by the computer is provided by a recording medium 1001 such as a CD-ROM or a memory card, for example. When a recording medium 1001 storing a program is set in the drive device 1000, the program is installed from the recording medium 1001 to the auxiliary storage device 1002 via the drive device 1000. Here, the program does not necessarily have to be installed from the recording medium 1001 and may be downloaded from another computer via the network. The auxiliary storage device 1002 stores installed programs as well as necessary files and data.

The memory device 1003 reads the program from the auxiliary storage device 1002 and stores it when a program activation command is received. The CPU 1004 implements functions relating to the control server 100 in accordance with programs stored in the memory device 1003. The Interface device 1005 is used as an interface for being connected to a network. A display device 1006 displays a graphical user interface (GUI) or the like by a program. An input device 1007 is composed of a keyboard, a mouse, buttons, a touch panel, or the like and is used for inputting various operational commands. The output device 1008 outputs the calculation result.

### (Effects of Embodiment)

With the technique described above, in a wireless communication system, movable base stations can be easily arranged at optimal locations according to the spatial environment, and system throughput can be improved.

### (Supplementary Note)

This specification discloses at least a communication system, a control server device, a base station disposition method, and a program according to the following items.

### (Item 1)

A communication system including a control server device and a movable base station device, comprising:
generating, by the control server device, one or more terminal clusters obtained by clustering terminal devices on the basis of information about a location and a material of each shielding object in an area and a location of each terminal device;
calculating, by the control server device, a location of a movable base station device for each of the terminal clusters; and
moving, by the control server device, the movable base station device to the calculated location in each of the terminal clusters.

### (Item 2)

The communication system according to item 1, wherein the control server device generates the one or more terminal clusters by calculating a distance between the terminal clusters on the basis of a distance for each set of terminal devices between the two terminal clusters, combining a combination of terminal clusters having a shortest distance between terminal clusters, and repeatedly performing a process of forming a new terminal cluster until the number of terminal clusters reaches a desired number.

### (Item 3)

The communication system according to item 2, wherein the control server device calculates a distance between a first terminal device and a second terminal device using an attenuation amount per thickness of a shielding object and the thickness of the shielding object when there is a shielding object between the first terminal device in one of the two terminal clusters and the second terminal device in the other terminal cluster.

### (Item 4)

The communication system according to any one of items 1 to 3, wherein the control server device performs calculation, for each of the terminal clusters in the one or more terminal clusters, a location in which the number of terminal devices in line of sight is greatest, a location in which a total radio wave attenuation amount is minimum, or a location of a center of gravity of the terminal cluster is a location of the movable base station device.

### (Item 5)

The communication system according to item 4, wherein the control server device calculates, when calculating the location of the center of gravity of the terminal cluster, a location of an initial center of gravity obtained by setting a weight of each of the terminal devices in the terminal cluster to one and a location of a center of gravity of the terminal cluster obtained by adding a weight to an attenuation amount of the shielding object to the terminal device when there is a shielding object between the terminals.

### (Item 6)

A control server device in a communication system including the control server device and a movable base, comprising: a base station control calculation unit which generates one or more terminal clusters obtained by clustering terminal devices on the basis of information about a location and a material of each shielding object in an area and a location of each terminal device and calculates a location of a movable base station device for each of the terminal clusters; and a base station control unit which moves the movable base station device to the calculated location in each of the terminal clusters.

### (Item 7)

A base station disposition method in a communication system including a control server device and a movable base station device, comprising:
a step of generating, by the control server device, one or more terminal clusters obtained by clustering terminal devices on the basis of information about a location and a material of each shielding object in an area and a location of each terminal device;
a step of calculating, by the control server device, a location of a movable base station device for each of the terminal clusters; and
a step of moving, by the control server device, the movable base station device to the calculated location in each of the terminal clusters.

### (Item 8)

A program for causing a computer to function as each unit in the control server device according to item 6.

Although the embodiment has been described above, the present invention is not limited to such a specific embodiment and various modifications and changes are possible within the scope of the gist of the invention described in the claims.

### REFERENCE SIGNS LIST

100 Control server
200 Movable base station
300 Terminal
400 Spatial information DB
110 Information communication I/F unit
120 Shielding object information acquisition unit
130 Terminal information acquisition unit
140 Base station control calculation unit
150 Base station control unit
160 Control communication I/F unit
210 Control communication I/F unit
220 Movable control unit
230 Terminal connection control unit
240 Wireless transmission/reception unit
1000 Drive device
1001 Recording medium
1002 Auxiliary storage device
1003 Memory device
1004 CPU
1005 Interface device
1006 Display device
1007 Input device

1. A communication system comprising:
a movable base station; and
a control server apparatus including circuitry configured to:
generate one or more terminal clusters that are obtained by clustering terminal devices based on (i) information about a location and a material of each of at least one shielding object in an area and (ii) a location of each terminal device;
determine a location of the movable base station for each of the one or more terminal clusters; and
move the movable base station to the determined location, for each of the one or more terminal clusters.

2. The communication system according to claim 1, wherein the circuitry of the control server apparatus is further configured to:
determine a distance between two terminal clusters among the one or more terminal clusters, based on a distance between terminal devices for each set of terminal devices that is selectable from the two terminal clusters, to thereby generate the one or more terminal clusters,
combine a combination of given terminal clusters that are identified as having a shortest distance between the given terminal clusters, and
repeatedly generate a new terminal cluster until the number of terminal clusters reaches a preset number.

3. The communication system according to claim 2, wherein the circuitry of the control server apparatus is further configured to determine a distance between a first terminal device and a second terminal device, by using (i) an attenuation amount per thickness of a given shielding object and (ii) the thickness of the given shielding object, in a case where the given shielding object is present between the first terminal device in one of the two terminal clusters and the second terminal device in the other terminal cluster.

4. The communication system according to claim 1, wherein the circuitry of the control server apparatus is further configured to determine, as the location of the movable base station, for each of two terminal clusters of the one or more terminal clusters,
a location at which a greatest number of terminal devices that are situated within a line of sight is obtained,
a location at which a smallest total radio wave attenuation amount is obtained, or
a location of a center of gravity of the terminal cluster.

5. The communication system according to claim 4, wherein the circuitry of the control server apparatus is further configured to determine, in a case of determining the location of the center of gravity of the terminal cluster,
a location of an initial center of gravity that is obtained by setting a weight for each terminal device in the terminal cluster to one, and
the location of the center of gravity of the terminal cluster that is obtained by adding a weight for an attenuation amount due to a given shielding object to a given terminal device, in a case where the given shielding object is situated between the terminal device and the given terminal device.

6. A control server apparatus comprising:
circuitry configured to:
generate one or more terminal clusters that are obtained by clustering terminal devices based on (i) information about a location and a material of each of at least one shielding object in an area and (ii) a location of each terminal device,
determine a location of a movable base station for each of the one or more terminal clusters, and
move the movable base station to the determined location, for each of the one or more terminal clusters.

7. A base station disposition method comprising:
generating, by a control server apparatus, one or more terminal clusters that are obtained by clustering terminal devices based on (i) information about a location and a material of each of at least one shielding object in an area and (ii) a location of each terminal device;
determining, by the control server apparatus, a location of a movable base station for each of the one or more terminal clusters; and
moving, by the control server apparatus, the movable base station to the determined location, for each of the one or more terminal clusters.

8. A non-transitory computer readable medium storing a program for causing a computer to execute the base station disposition method of claim 7.
